(19) United States
(12) Patent Application Publication
(10) Pub. No.: US 2003/0194933 A1
(43) Pub. Date: Oct. 16, 2003

(54) Chopped glass strand mat and method of producing same

(75) Inventor: Tushar M. Patel, Troy, MI (US)

Correspondence Address: BROOKS & KUSHMAN, 1000 TOWN CENTER 22ND FL, SOUTHFIELD, MI, 48075

(73) Assignee: H.R. Technologies, Inc., Sterling Heights, MI

(21) Appl. No.: 10/123,269

(22) Filed: Apr. 16, 2002

(51) Int. Cl. B32B 5/02; B32B 27/04

(52) U.S. Cl. 442/149; 442/150; 442/394; 442/391; 428/346; 156/62.2

(57) ABSTRACT

A glass strand mat is produced by placing a first layer of glass filaments on a moving belt. An adhesive web binder is placed over the first layer of glass filaments, and a second layer of glass filaments is placed over the adhesive web binder. The glass filaments and the adhesive web binder are captured by a second moving belt, and heat and pressure are applied. The two layers of glass filaments are bonded together into a glass mat which is then cooled and wound into a roll.

### BACKGROUND OF THE INVENTION

1. Field of the Invention

The present invention relates to a chopped glass strand mat and a method of producing the mat.

2. Background Art

The use of glass filaments in composite materials is well known. Typically, the glass filaments are employed to strengthen and stiffen a material, such as a polymeric material, that would otherwise not have the desired properties for a given application.

One method of producing a glass filament reinforced composite involves distributing loose glass filaments throughout a polymeric matrix. U.S. Pat. No. 5,716,697 issued to Meeker on Feb. 10, 1998 describes a composite produced by such a process. A layer of glass filaments is first distributed on a polymer sheet. A second polymer sheet is placed over the filaments such that the loose filaments are now captured between two polymer sheets. Heat and pressure are applied to the layers which are laminated together to form a composite material. A composite material produced by this method requires the producer to handle loose glass filaments and to set up a rather complex production method, by which the loose filaments are uniformly distributed between the first and second polymer sheets. The uniform distribution of the filaments helps to ensure that the final composite material obtains the desired properties, and that these properties are uniform throughout the composite. The need to isolate and distribute the skin irritating loose glass filaments adds complexity and increases the cost of the production of the composite material. In addition, the production of some composite materials requires the reinforcing glass filaments to be preformed into a particular shape and placed into a mold prior to the introduction of the polymer material. In the production of these types of materials, loose glass filaments cannot be used.

One attempt to overcome some of the difficulties of working with loose glass filaments in the production of a composite material is described in U.S. Pat. No. 5,063,103 issued to Sugawara et al. on Nov. 5, 1991. Sugawara et al. describes the production of a reinforced polymeric matrix using a glass mat bonded with a hydrocarbon polymer, rather than using loose glass filaments. The glass mat can be produced by mixing chopped glass strands with a powder binder, and then heat-pressing the mixture. A mat thus produced can then be used in the production of a composite material either as a substitute for loose glass filaments, or by cutting the mat into a particular shape and placing it into a mold.

One inherent limitation of glass mats produced with powder binders is the difficulty in getting a uniform distribution of the binder material. This problem is manifest even where an aqueous emulsion is used in place of the powder binder. When the binder is not uniformly distributed among the glass filaments, the bonding surface area is reduced and the resulting glass mat has a low tensile strength which results in a number of problems. A glass mat having a low tensile strength requires careful handling because it is prone to breaking. In addition, the low tensile strength may limit the size of the mat. For example, it is often convenient to wind glass mats into large rolls. In this form, the mats take up less space, they can be more easily stored and transported, and they can be unrolled to a desired size. Glass mats having a low tensile strength can only be put on small rolls since unwinding such a glass mat from a large roll, which has an inherently high inertia, is likely to cause breakage.

Accordingly, it is desirable to provide a chopped glass strand mat that has a uniformly distributed binder such that there is a large surface area of bonding between the glass filaments, resulting in a glass mat that has a relatively high tensile strength.

### SUMMARY OF THE INVENTION

One aspect of the present invention provides a glass strand mat having an adhesive web binder distributed throughout the mat with a high degree of uniformity.

Another aspect of the invention provides a glass strand mat having sufficient tensile strength so that it can be wound into, and unwound from, relatively large rolls.

A further aspect of the invention provides a method of producing a glass strand mat having the aforementioned properties.

Accordingly, a method of producing a glass strand mat is provided, which comprises distributing a first layer of glass filaments onto a surface. An adhesive web binder is then disposed over the first layer of glass filaments, and a second layer of glass filaments is distributed over the adhesive web binder, thereby creating a lay-up. The lay-up is then heated to a temperature sufficient to at least partially melt the adhesive web binder, and then it is compacted to form the glass strand mat.

Another aspect of the invention provides a method of producing a glass strand mat which comprises placing a plurality of glass filaments in contact with a first side of an adhesive web binder. Additional glass filaments are placed in contact with a second side of the adhesive web binder. The adhesive web binder is then heated to a temperature sufficient to at least partially melt the adhesive web binder, and the adhesive web binder and glass filaments are then compacted.

A further aspect of the invention provides a glass strand mat which comprises a plurality of glass filaments disposed to form a sheet-like structure, and an adhesive web binder at least a part of which binds at least some of the filaments to other filaments.

Another aspect of the invention provides a glass strand mat which comprises a first layer of glass filaments, a second layer of glass filaments, and an adhesive web binder substantially disposed between the two layers of filaments such that it binds at least some of the first layer of filaments to at least some of the second layer of filaments.

The above object and other objects, features, and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic representation of a process used to produce a glass strand mat in accordance with the present invention.

### DETAILED DESCRIPTION OF THE PREFERRED EMBODIMENTS

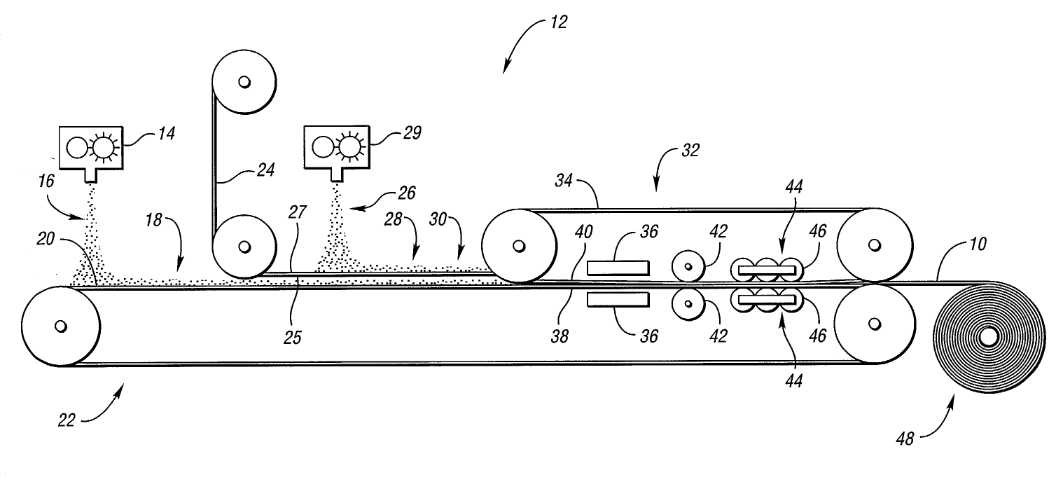

The schematic representation shown in FIG. 1 illustrates one method of producing a glass strand mat 10 in accordance with the present invention. The production system 12 includes a first chopper 14 into which glass rovings are fed. The glass rovings comprise individual glass strands, or filaments, arranged generally parallel to one another in a large group. The glass rovings are chopped into filaments 16 by the first chopper 14. It should be noted that a typical chopping process does not completely reduce a roving into individual filaments. Rather, chopping a roving usually results in a combination of filaments (individual glass strands) and bundles (filaments arranged generally parallel to one another in small groups). Therefore, except as specifically noted, the term “filaments” includes individual filaments, bundles, or a combination thereof.

After the rovings are chopped in the first chopper 14, the glass filaments 16 are then distributed in a first layer 18 onto a first surface 20 of a first moving belt 22. The first moving belt 22 is made from, or at least the first surface 20 is coated with, a non-stick material such as Teflon®. The reason for using a nonstick surface becomes clear as the process proceeds. The glass filaments 16 are distributed approximately uniformly in a first distribution density onto the first surface 20 of the first moving belt 22. This helps to ensure that the glass mat 10 will have uniform properties, which also helps to ensure a similar uniformity in any composite material that utilizes the glass mat 10.

The distribution of the glass filaments 16 in the first layer 18 is controlled by a number of parameters which help determine not only the distribution density, but also the degree of uniformity of the distribution. For example, the rate at which the glass filaments 16 leave the first chopper 14, and the speed of the first moving belt 22, both affect the distribution density of the glass filaments 16. In addition, holding constant the rate at which the glass filaments 16 leave the first chopper 14 helps to ensure that the glass filaments 16 are distributed uniformly. Similarly, keeping the speed of the first moving belt 22 constant, also helps to ensure a uniform distribution of the glass filaments 16.

Typically, the distribution density of the glass filaments 16 in the first layer 18 is between 30 g/m² and 170 g/m², with a variation of plus or minus 10% owing to process variables. The distribution density is adjustable to meet the needs of a particular application, and although glass mats having distribution densities that fall within this range will be suitable for many applications, glass mats having distribution densities outside this range are contemplated by the present invention. Similarly, the size of the glass filaments 16 is also adjustable so that the glass mat 10 can be tailored to particular applications. The first chopper 14 can be configured to chop the glass filaments 16 into shorter or longer lengths, and changing this configuration can be done independently of changing the distribution density. The glass mat 10 can therefore be made with uniform properties, and through simple adjustments of the first chopper 14 and the speed of the first moving belt 22, these properties can be easily altered.

As the first layer 18 of glass filaments 16 is carried along by the first moving belt 22, an adhesive web binder 24 having a first side 25 and a second side 27, is placed over the first layer 18. The adhesive web binder 24 is essentially a dry adhesive material that takes the place of the adhesive powder or aqueous emulsions used to manufacture other types of glass strand mats. Typically, the adhesive web binder 24 is made from one of a number of different thermoplastic polymers. These can include polyolefin, polyester, polyamide, and polymeric adhesives or a combination thereof. The adhesive web binder 24 is of course not limited to these materials.

An adhesive web binder such as 24 shown in FIG. 1 may be purchased from a vendor already rolled and ready for use on a production line. One example of this type of adhesive web binder is a product called Spunfab®, made by Spunfab, Ltd. Alternatively, the adhesive web binder may be produced as needed at the site of the production line. Typically this involves spraying and/or spinning a molten polymeric material to form the adhesive web binder as it is being used. Use of an adhesive web binder such as 24, as opposed to powdered adhesives or even liquid emulsions, helps to ensure that the adhesive is uniformly distributed throughout the glass mat 10. This increases the surface area of bonding and therefore makes the glass mat 10 stronger.

After the adhesive web binder 24 is placed over the first layer 18 of glass filaments 16, additional glass filaments 26 are distributed in a second distribution density in a second layer 28 over the adhesive web binder 24. Similar to the glass filaments 16, the glass filaments 26 are produced by feeding glass rovings into a second chopper 29. The second chopper 29 is typically configured to produce glass filaments 26 of approximately the same size as the glass filaments 16. Moreover, the second distribution density is approximately equal to the first distribution density. That is, the glass filaments 26 are uniformly distributed in the second layer 28 with approximately the same distribution density as the glass filaments 16 in the first layer 18. Again, uniform distribution is achieved by controlling the rate at which the glass filaments 26 leave the second chopper 29 and the speed at which the adhesive web binder 24 is moving. The speed of the adhesive web binder 24 is dictated by the speed of the first moving belt 22, and as explained below, the speed of a second moving belt 32. Having approximately equal distribution densities of glass filaments 16, 26 in both layers 18, 28 helps to promote better bonding between the layers 18, 28, which in turn helps to make the glass mat 10 stronger.

It is important to note that as the glass filaments 16, 26 are distributed into the first and second layers 18, 28, some of the filaments will lie over other filaments even within an individual layer. Moreover, the orientation of some of the filaments 16, 26 may be such that they at least partially traverse the adhesive web binder 24, and contact filaments in both layers 18, 28. Thus, the term “layer” as used herein, is not limited to a single thickness or diameter of glass filament, nor does it imply a complete segregation of filaments between layers. Rather, the term “layer”, as used throughout, is meant to describe the general orientation of the glass filaments and the adhesive web binder, in relation to each other.

The combination of the first layer 18, the adhesive web binder 24, and the second layer 28 is commonly referred to as a “lay-up” 30. The lay-up 30 continues to move along the first moving belt 22 until it reaches the second moving belt 32, which also has at least a non-stick first surface 34. The lay-up 30 is then captured between the first surface 20 of the first moving belt 22 and the first surface 34 of the second moving belt 32. Thus, the moving belts 22, 32 move at approximately equal linear speeds and dictate the speed of the lay-up 30, and therefore the speed of the adhesive web binder 24. As it is carried along by the moving belts 22, 32, the captured lay-up 30 is then heated by heating elements 36 that are disposed in close proximity to second surfaces 38, 40 of the moving belts 22, 32. Typically, the heating elements 36 employ resistive heating to raise the temperature of the lay-up 30; however, radiant or other types of heating apparatuses are contemplated by the present invention.

As the lay-up 30 moves past the heating elements 36, the temperature of the adhesive web binder 24 increases until it begins to at least partially melt. At this point, pressure is applied to compact the lay-up 30, preferably via pinch rollers 42 which are in contact with the second surfaces 38, 40 of the moving belts 22, 32. It is for this reason that the moving belts 22, 32 have at least non-stick first surfaces 18, 28: it helps to keep the partially melted adhesive web binder from sticking to the moving belts 22, 32. The pinch rollers 42 are typically configured to apply 3 N10 N of force to the heated lay-up 30 to achieve the desired compaction. The pinch rollers 42 are convenient to use with moving belts such as 22, 32, though other methods of applying the force are also contemplated. The application of the compaction force helps to ensure a high degree of bonding between the first layer 18 of the glass filaments 16 and the second layer 28 of the glass filaments 26. It is here that some of the benefits of using the adhesive web binder 24 are realized. Unlike powder binders which are prone to fall out of the glass mat before they are heated, or even aqueous adhesive emulsions which do not adhere uniformly to the glass filaments, the adhesive web binder 24 remains uniformly distributed throughout the glass mat 10. This helps to ensure a high degree of bonding and a large bonding area, which increases the strength of the glass mat 10.

After the lay-up 30 has been heated by the heating elements 36 and pressed by the pinch rollers 42, it is now a glass mat that will typically be cooled before it is wound into a roll. A convenient method for cooling the recently pressed glass mat involves the use of cooling elements 44 disposed along the second surfaces 38, 40 of the moving belts 22, 32. The cooling elements 44 include a series of water tubes 46 that are in contact with the second surfaces 38, 40 of the moving belts 22, 32. Cooling water is circulated through the tubes 46 to facilitate heat transfer from the newly pressed glass mat to the water which is continuously circulated to ensure good heat transfer.

Finally, as the cooled glass mat 10 exits the moving belts 22, 32, it is wound into a roll by a winder 48 so that it can be easily stored and transported. The superior strength of the glass mat 10, resulting from the use of the adhesive web binder 24, allows the winder 48 to roll much larger quantities of the glass mat 10 than is possible with conventional glass mats made with powder binders or aqueous emulsion binders. This reduces the frequency with which a new roll is placed on the winder 48, and therefore increases efficiency and reduces costs. Although the glass mat 10 is preferably produced in a continuous roll as described above, individual sheets can also be produced. When such sheets are produced, it will typically involve placing a plurality of glass filaments in contact with a first side of an adhesive web binder (such as 24 in FIG. 1). Additional glass filaments are then placed in contact with a second side of the adhesive web binder to form a lay-up. The lay-up is then heated and compacted to form the glass strand mat, which is then cooled to complete the process.

Regardless of the method used, the glass mats produced in accordance with the present invention generally have two layers of glass filaments, though a single layer of glass filaments may be used if a particular application so dictates. The glass filaments are arranged in a sheet-like structure and bonded together by an adhesive web binder. Although the terms “first and second layers” are used to describe the arrangement of the glass filaments in the embodiments described above, some overlap of the filaments between layers is contemplated.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of producing a glass strand mat, comprising:
distributing a first layer of glass filaments onto a surface;
disposing an adhesive web binder over the first layer of glass filaments;
distributing a second layer of glass filaments over the adhesive web binder, thereby creating a lay-up;
heating the lay-up to a temperature sufficient to at least partially melt the adhesive web binder; and
compacting the lay-up to create the glass strand mat.

2. The method of claim 1, wherein distributing the first layer of glass filaments comprises distributing the filaments with an approximately uniform first distribution density.

3. The method of claim 2, wherein distributing a second layer of glass filaments comprises distributing the filaments with an approximately uniform second distribution density nearly equal to the first distribution density.

4. The method of claim 2, wherein the first distribution density is in the range of 30 g/m² to 170 g/m².

5. The method of claim 1, further comprising producing the adhesive web binder prior to disposing it over the first layer of glass filaments.

6. The method of claim 5, wherein the adhesive web binder is produced from at least one molten polymeric material.

7. The method of claim 1, wherein distributing a first layer of glass filaments onto a surface comprises distributing the filaments onto a first surface of a first moving belt.

8. The method of claim 7, further comprising capturing the lay-up between the first surface of the first moving belt and a first surface of a second moving belt.

9. The method of claim 8, wherein heating the lay-up occurs after the lay-up is captured between the belts.

10. The method of claim 9, wherein compacting the lay-up to create the glass strand mat comprises moving the belts and the lay-up through pinch rollers contacting a second surface of each belt.

11. The method of claim 10, further comprising cooling the glass strand mat with a cooling apparatus after the lay-up is compacted into the glass strand mat.

12. The method of claim 11, further comprising winding the glass strand mat into a roll after the glass strand mat is cooled with the cooling apparatus.

13. A method of producing a glass strand mat, comprising:
placing a plurality of glass filaments in contact with a first side of an adhesive web binder;
placing additional glass filaments in contact with a second side of the adhesive web binder;
heating the adhesive web binder to a temperature sufficient to at least partially melt the adhesive web binder; and
compacting the adhesive web binder and glass filaments to create the glass strand mat.

14. The method of claim 13, further comprising cooling the glass strand mat with a cooling apparatus after the filaments and binder are compacted into the glass strand mat.

15. The method of claim 13, further comprising producing the adhesive web binder from at least one molten polymeric material.

16. The method of claim 13, wherein the plurality of glass filaments are placed in contact with the first side of the adhesive web binder with an approximately uniform first distribution density.

17. The method of claim 16, wherein the first distribution density is in the range of 30 g/m² to 170 g/m².

18. The method of claim 16, wherein the additional glass filaments are placed in contact with the second side of the adhesive web binder with an approximately uniform second distribution density nearly equal to the first distribution density.

19. A glass strand mat, comprising:
a plurality of glass filaments arranged to form a sheet-like structure; and
an adhesive web binder, at least a part of which binds at least some of the filaments to other filaments.

20. The glass strand mat of claim 19, wherein the glass filaments comprise a first layer of filaments substantially disposed on a first side of the adhesive web binder, and a second layer of filaments substantially disposed on a second side of the adhesive web binder.

21. The glass strand mat of claim 20, wherein the first layer of filaments has an approximately uniform first distribution density, and the second layer of filaments has an approximately uniform second distribution density nearly equal to the first distribution density.

22. The glass strand mat of claim 20, wherein the first distribution density is in the range of 30 g/m² to 170 g/m².

23. A glass strand mat, comprising:
a first layer of glass filaments;
a second layer of glass filaments; and
an adhesive web binder substantially disposed between the two layers of filaments and binding at least some of the first layer of glass filaments to at least some of the second layer of glass filaments.
